(19) United States
(12) Patent Application Publication
(10) Pub. No.: US 2011/0249576 A1
(43) Pub. Date: Oct. 13, 2011

(54) ANTENNA SELECTION BASED ON PERFORMANCE METRICS IN A WIRELESS DEVICE

(75) Inventors: George Chrisikos, San Diego, CA (US); Richard Dominic Wietfeldt, San Diego, CA (US)

(73) Assignee: QUALCOMM Incorporated, San Diego, CA (US)

(21) Appl. No.: 12/900,270

(22) Filed: Oct. 7, 2010

Related U.S. Application Data
(60) Provisional application No. 61/288,801, filed on Dec. 21, 2009.

(51) Int. Cl. H04W 24/00

(52) U.S. Cl. 370/252

(57) ABSTRACT

Techniques for supporting a plurality of radios on a wireless device with a limited number of antennas are described. In one design, at least one radio may be selected from among the plurality of radios on the wireless device. At least one performance metric may be determined and may include a performance metric related to isolation between antennas, or correlation between antennas, or throughput, or link capacity, or interference, or power consumption of the wireless device, or received signal quality at the wireless device. In one design, an objective function may be determined based on the at least one performance metric. At least one antenna may be selected for the at least one radio from among a plurality of antennas based on the at least one performance metric, e.g., based on the objective function. The at least one radio may be connected to the at least one antenna.

The present application claims priority to provisional U.S. Application Ser. No. 61/288,801, entitled “METHOD AND APPARATUS FOR ANTENNA SWITCHING IN A WIRELESS SYSTEM,” filed Dec. 21, 2009, assigned to the assignee hereof and incorporated herein by reference.

### BACKGROUND

I. Field

The present disclosure relates generally to communication, and more specifically to techniques for supporting communication by a wireless communication device.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication device may include a number of radios to support communication with different wireless networks. Each radio may transmit or receive signals via one or more antennas. The number of antennas on the wireless device may be limited due to space constraints and coupling issues. It may be desirable to support all radios on the wireless device with a limited number of antennas such that good performance can be achieved.

### SUMMARY

Techniques for supporting a plurality of radios on a wireless communication device with a limited number of antennas are described herein. In an aspect, to reduce the number of antennas needed to support all of the radios on the wireless device, one or more antennas may be shared between radios. Furthermore, antennas may be selected for one or more active radios such that good performance can be obtained.

In one design, at least one radio may be selected from among the plurality of radios on the wireless device. At least one performance metric may be determined. At least one antenna may be selected for the at least one radio from among a plurality of antennas based on the at least one performance metric. The at least one radio may be connected to the at least one antenna.

In general, the at least one performance metric may include any type of performance metric and any number of performance metrics. In one design, the at least one performance metric may include a performance metric related to isolation between antennas or correlation between antennas. In another design, the at least one performance metric may include a performance metric related to throughput, or link capacity, or interference, or power consumption of the wireless device, or received signal quality at the wireless device. The at least one performance metric may also include a combination of different performance metrics. In one design, an objective function may be determined based on the at least one performance metric. The at least one antenna may then be selected based on the objective function, e.g., with an algorithm that optimizes the objective function, possibly subject to certain constraints.

Various aspects and features of the disclosure are described in further detail below.

### BRIEF DESCRIPTION OF THE DRAWINGS

FIG. 1 shows a wireless device communicating with various wireless networks.

FIG. 2 shows a block diagram of the wireless device.

FIG. 3 shows an exemplary layout of various units within the wireless device.

FIG. 4 shows different levels of antenna sharing by seven wireless devices.

FIG. 5 shows a block diagram of a switchplexer.

FIG. 6 shows an example of dynamic antenna selection.

FIGS. 7A and 7B show two designs of a configurable antenna.

FIGS. 8A and 8B show two designs of an impedance control element.

FIG. 9 shows measurement of pair-wise isolation for two antennas.

FIG. 10 shows measurement of joint isolation for three or more antennas.

FIG. 11 shows a process for selecting antennas based on isolation and/or correlation between antennas.

FIG. 12 shows a process for dynamically selecting antennas.

FIG. 13 shows a process for performing antenna selection based on at least one performance metric.

### DETAILED DESCRIPTION

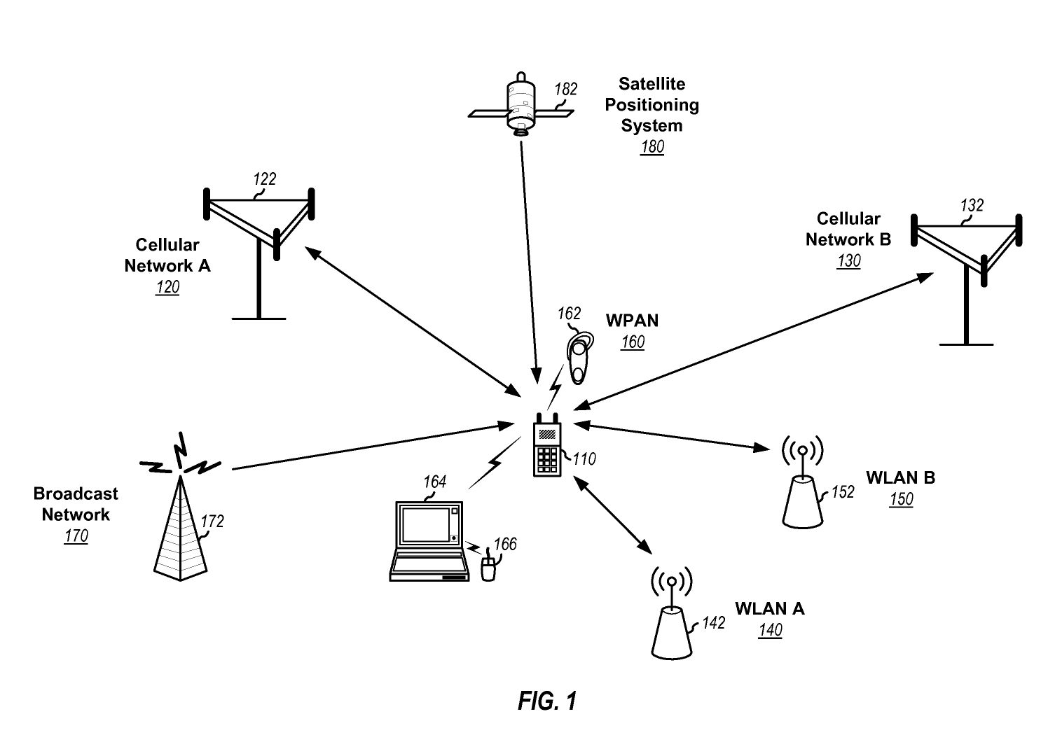

FIG. 1 shows a wireless communication device 110 capable of communicating with multiple wireless communication networks. These wireless networks may include one or more wireless wide area networks (WWANs) 120 and 130, one or more wireless local area networks (WLANs) 140 and 150, one or more wireless personal area networks (WPANs) 160, one or more broadcast networks 170, one or more satellite positioning systems 180, other networks and systems not shown in FIG. 1, or any combination thereof. The terms “network” and “system” are often used interchangeably. The WWANs may be cellular networks.

Cellular networks 120 and 130 may each be a CDMA, TDMA, FDMA, OFDMA, SC-FDMA, or some other network. A CDMA network may implement a radio technology or air interface such as Universal Terrestrial Radio Access (UTRA), cdma2000, etc. UTRA includes Wideband CDMA (WCDMA) and other variants of CDMA. cdma2000 covers IS-2000, IS-95, and IS-856 standards. IS-2000 is also referred to as CDMA 1×, and IS-856 is also referred to as Evolution-Data Optimized (EVDO). A TDMA network may implement a radio technology such as Global System for Mobile Communications (GSM), Digital Advanced Mobile Phone System (D-AMPS), etc. An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2”. Cellular networks 120 and 130 may include base stations 122 and 132, respectively, which can support bi-directional communication for wireless devices.

WLANs 140 and 150 may each implement a radio technology such as IEEE 802.11 (Wi-Fi), Hiperlan, etc. WLANs 140 and 150 may include access points 142 and 152, respectively, which can support bi-directional communication for wireless devices. WPAN 160 may implement a radio technology such as Bluetooth (BT), IEEE 802.15, etc. WPAN 160 may support bi-directional communication for various devices such as wireless device 110, a headset 162, a computer 164, a mouse 166, etc.

Broadcast network 170 may be a television (TV) broadcast network, a frequency modulation (FM) broadcast network, a digital broadcast network, etc. A digital broadcast network may implement a radio technology such as MediaFLO™, Digital Video Broadcasting for Handhelds (DVB-H), Integrated Services Digital Broadcasting for Terrestrial Television Broadcasting (ISDB-T), Advanced Television Systems Committee—Mobile/Handheld (ATSC-M/H), etc. Broadcast network 170 may include one or more broadcast stations 172 that can support one-way communication.

Satellite positioning system 180 may be the United States Global Positioning System (GPS), the European Galileo system, the Russian GLONASS system, the Japanese Quasi-Zenith Satellite System (QZSS), the Indian Regional Navigational Satellite System (IRNSS), the Chinese Beidou system, etc. Satellite positioning system 180 may include a number of satellites 182 that transmit signals used for positioning.

Wireless device 110 may be stationary or mobile and may also be referred to as a user equipment (UE), a mobile station, a mobile equipment, a terminal, an access terminal, a subscriber unit, a station, etc. Wireless device 110 may be a cellular phone, a personal digital assistant (PDA), a wireless modem, a handheld device, a laptop computer, a cordless phone, a wireless local loop (WLL) station, a smart phone, a netbook, a smartbook, a broadcast receiver, etc. Wireless device 110 may communicate two-way with cellular networks 120 and/or 130, WLANs 140 and/or 150, devices within WPAN 160, etc. Wireless device 110 may also receive signals from broadcast network 170, satellite positioning system 180, etc. In general, wireless device 110 may communicate with any number of wireless networks and systems at any given moment.

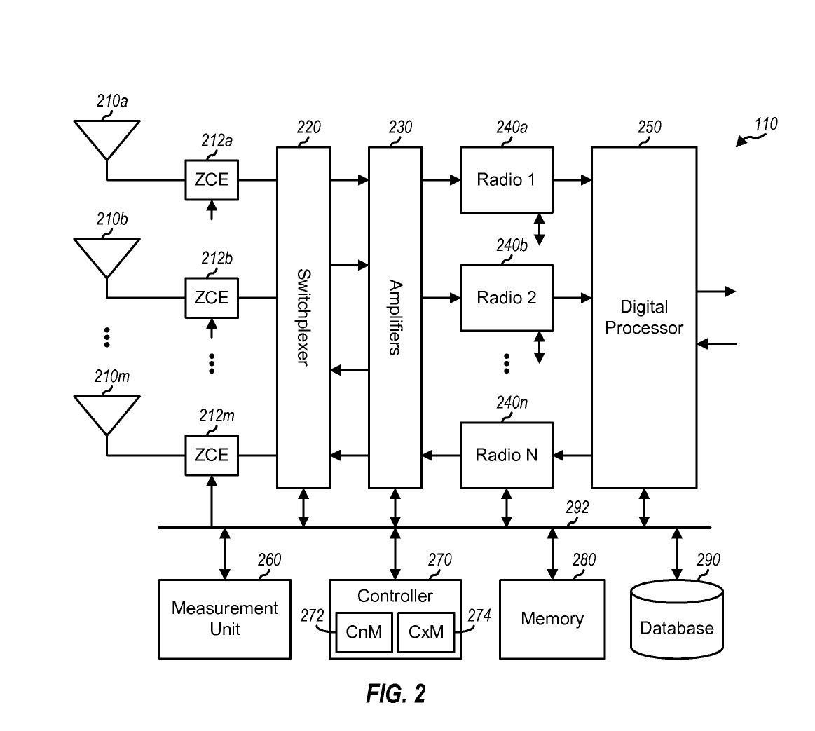

FIG. 2 shows a block diagram of a design of wireless device 110. In this design, wireless device 110 includes M antennas 210a through 210m and N radios 240a through 240n. In general, M and N may each be any integer value. In one design, M is less than N, and some radios may share antennas.

Antennas 210 may comprise elements used to radiate and/or receive signals and may also be referred to as antenna elements. Antennas 210 may be implemented with various antenna designs and shapes. For example, an antenna may be a dipole antenna, a printed dipole antenna, a monopole antenna, a patch/planar antenna, a whip antenna, a microstrip antenna, a stripline antenna, an inverted F antenna, a planar inverted F antenna, a plate antenna, etc. Antennas 210 may include passive and/or active elements, fixed and/or configurable elements, etc. A configurable antenna may be varied in terms of its dimension or size, its electrical characteristics, etc. For example, an antenna may comprise multiple segments that may be turned on or off or may be used as an array for beamforming and/or beamsteering.

In the design shown in FIG. 2, antennas 210a through 210m may be coupled to impedance control elements (ZCE) 212a through 212m, respectively. Each impedance control element 212 may perform tuning and matching for an associated antenna 210. For example, an impedance control element may dynamically and adaptively change the operating frequency band and range (e.g., the center frequency and bandwidth) of an associated antenna, control steering of beam direction and null, manage mismatch between a selected radio and one or more selected antennas, control isolation between antennas, etc. In one design, impedance control elements 212a through 212m may be controlled by a controller 270 via a bus 292.

A configurable switchplexer 220 may couple selected radios 240 to selected antennas 210. Based on appropriate inputs, all or a subset of radios 240 may be selected for use, and all or a subset of antennas 210 may also be selected for use. Switchplexer 220 may provide a configurable antenna switch matrix with the ability to map the selected radios to the selected antennas. The configuration and operation of switchplexer 220 may be controlled by controller 270 via bus 292. Each selected antenna 210 may be used for one or more selected radios 240 and for a suitable frequency band, e.g., under control of controller 270. Controller 270 may configure the selected antennas 210 for receive diversity, selection diversity, multiple-input multiple-output (MIMO), beamforming, or some other transmission and/or reception schemes for the selected radios 240. Controller 270 may also allocate multiple diversity antennas during a voice or data connection and may switch between different antennas (e.g., WWAN antennas and WLAN antennas) depending on which radio(s) are selected for use. Controller 270 in combination with switchplexer 220 may control antennas 210 for beamsteering, nulling, etc. Switchplexer 220 may be implemented within a radio frequency integrated circuit (RFIC), which may include other circuits. Alternatively, switchplexer 220 may be implemented with one or more external (e.g., discrete) components.

Amplifiers 230 may include one or more low noise amplifier (LNAs) for receiver radios, one or more power amplifiers (PAs) for transmitter radios, and/or other amplifiers. In one design, amplifiers 230 may be part of radios 240, and each amplifier may be used for a specific radio. In another design, amplifiers 230 may be shared between radios 240, as appropriate. For example, a given LNA may support multiple receiver radios operating on the same frequency band (e.g., 2.4 GHz) and may be selected for use for any one of these receiver radios at any given moment. Similarly, a given PA may support multiple transmitter radios operating on the same frequency band and may be selected for use for any one of these transmitter radios at any given moment. Controller 270 may control amplifiers 230 and radios 240. In one design, write-only capability may be supported, and controller 270 may control the operation of amplifiers 230 and radios 240 based on available information. In another design, read-and-write capability may be supported, and controller 270 may retrieve information regarding amplifier 230 and/or radio 240 and may use the retrieved information to control its operation and/or the operation of amplifiers 230 and radios 240. Switchplexer 220 may be used to allocate and share amplifiers 230 (e.g., LNAs and/or PAs), which may reduce the number of amplifiers needed to support all of the radios 240 on wireless device 110.

Radios 240a through 240n may support communication for wireless device 110 with any of the networks and systems described above and/or other networks or systems. For example, radios 240 may support communication with 3GPP2 cellular networks (e.g., CDMA 1×, 1×EVDO, etc.), 3GPP cellular networks (e.g., GSM, GPRS, EDGE, WCDMA, HSPA, LTE, etc.), WLANs, WiMAX networks, GPS, Bluetooth, broadcast networks (e.g., TV, FM, MediaFLO™, DVB-H, ISDB-T, ATSC-M/H, etc.), Near Field Communication (NFC), Radio Frequency Identification (RFID), etc. Radios 240 may include transmitter radios that can generate output radio frequency (RF) signals and receiver radios that can process received RF signals. Each transmitter radio may receive one or more baseband signals from a digital processor 250, process the baseband signal(s), and generate one or more output RF signals for transmission via one or more antennas. Each receiver radio may obtain one or more received RF signals from one or more antennas, process the received RF signal(s), and provide one or more baseband signals to digital processor 250. Each radio may perform various functions such as filtering, duplexing, frequency conversion, gain control, etc.

Digital processor 250 may couple to radios 240a through 240n and may perform various functions such as processing for data being transmitted or received via radios 240. The processing for each radio 240 may be dependent on the radio technology supported by that radio and may include encoding, decoding, modulation, demodulation, encryption, decryption, etc.

A measurement unit 260 may monitor and measure various characteristics of antennas 210 and/or quantities related to antennas 210. The measurements may be for isolation between antennas, received signal strength indicator (RSSI), etc. The measurements may be used to select antennas for radios, to adjust the operating characteristics of the selected antennas to obtain good performance, etc. Measurement unit 260 may also monitor and measure various characteristics and/or quantities related to other units within wireless device 110, such as radios 240. Measurement unit 260 may be controlled (e.g., by controller 270 via bus 292) to make measurements and provide results. Although not shown in FIG. 2 for simplicity, measurement unit 260 may also interface with switchplexer 220, antennas 210, and/or radios 240 in order to provide test signals to the radios and/or antennas and to measure signals at the radios and/or antennas. The operation of measurement unit 260 is described in detail below.

Controller 270 may control the operation of various units within wireless device 110. In one design, controller 270 may include a connection manager (CnM) 272 that may select radios for active applications on wireless device 110 to obtain good performance for the applications. In one design, controller 270 may include a coexistence manager (CxM) 274 that may control the operation of radios in order to obtain good performance. Connection manager 272 and/or coexistence manager 274 may have access to a database 290, which may store information used to select radios and/or antennas, to control the operation of radios and/or antennas, etc. A memory 280 may store data and program codes for various units within wireless device 110. Memory 280 may also store database 290.

In one design that is shown in FIG. 2, bus 292 may interconnect various units within wireless device 110 and may support communication (e.g., exchange of data and control messages) between these various units. Bus 292 may be designed to meet bandwidth and latency requirements of all units relying on the bus. Bus 292 may be implemented with various designs such as a SLIMbus, etc. Bus 292 may also operate in a synchronous or asynchronous manner. In another design that is not shown in FIG. 2, communication between certain units within wireless device 110 may be achieved via one or more other buses and/or dedicated control lines. For example, a serial bus interface (SBI) may be coupled to impedance control elements 212, switchplexer 220, amplifiers 230, radios 240, and controller 270. The SBI may be used to control the operation of various RF circuits.

For simplicity, one digital processor 250, one controller 270, and one memory 280 are shown in FIG. 2. In general, digital processor 250, controller 270, and memory 280 may comprise any number and any type of processors, controllers, memories, etc. For example, digital processor 250 and controller 270 may comprise one or more processors, microprocessors, central processing units (CPUs), digital signal processors (DSPs), reduced instruction set computers (RISCs), advanced RISC machines (ARMs), controllers, etc. Digital processor 250, controller 270, and memory 280 may be implemented on one or more integrated circuits (ICs), application specific integrated circuits (ASICs), etc. For example, digital processor 250, controller 270, and memory 280 may be implemented on a Mobile Station Modem (MSM) ASIC.

FIG. 2 shows an exemplary design of wireless device 110. Wireless device 110 may also include different and/or other units not shown in FIG. 2.

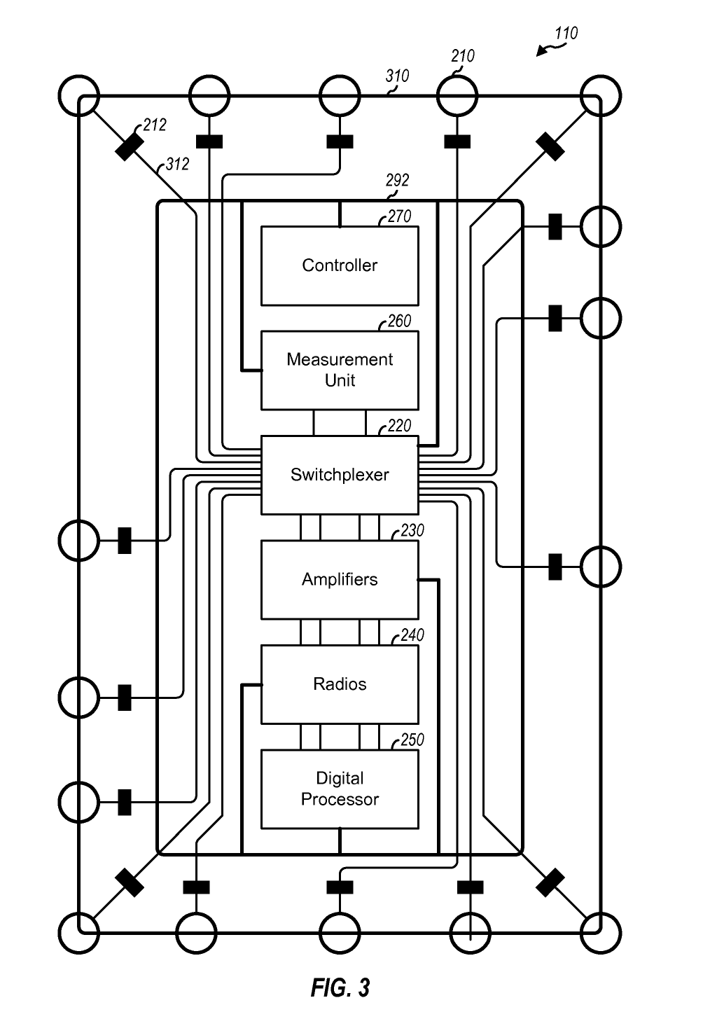

FIG. 3 shows an exemplary layout of various units within wireless device 110. An outline 310 may represent a physical casing of wireless device 110. Antennas 210 are represented by circles, and impedance control elements 212 are represented by black boxes in FIG. 3. Antennas 210 may be formed near the edges of the physical casing (as shown in FIG. 3) or may be distributed throughout the physical casing or on any printed circuit board (PCB) (not shown in FIG. 3). Impedance control elements 212 may be coupled between antennas 210 and switchplexer 220. Each impedance control element 212 may be located near an associated antenna 210 and may be coupled to a physical trace 312 that interconnects the associated antenna 210 to switchplexer 220. Physical traces 312 may be fabricated on or embedded within a printed circuit board or may be implemented with RF cables and/or other cables. Each impedance control element 212 may also be coupled to bus 292 (not shown in FIG. 3) and may be controlled by controller 270 via bus 292. Switchplexer 220 may couple to antennas 212 via physical traces 312 and may also couple to amplifiers 230. Amplifiers 230 may further couple to radios 240, which may be coupled to digital processor 250. Measurement unit 260 may couple to switchplexer 220 and may provide and/or measure signals on physical traces 312. Controller 270 may control the operation of various units within wireless device 110 via bus 292.

Wireless device 110 typically has a small size that limits the number of antennas that can be supported on a particular platform. The number of antennas required by wireless device 110 may be dependent on the number of radios and the number of frequency bands supported by wireless device 110. More antennas may also be required to support various operating modes such as diversity reception, transmit beamforming, MIMO, etc. Dedicated antennas may be used to support different radios, frequency bands, and operating modes. In this case, a relatively large number of antennas may be required for all of the radios, frequency bands, and operating modes supported by wireless device 110.

Table 1 lists an exemplary set of antennas for a wireless device. As shown in

Table 1, a large number of antennas may be required to support different radios, frequency bands, and operating modes. More antennas may be required to support more radios and frequency bands than those listed in

Table 1. For example, future wireless devices may support 40 or more frequency bands specified in 3GPP and 3GPP2 standards.

TABLE 1

| Radio Technology | Frequency Bands (MHz) | Ant1 | Ant2 | Total |
|---|---|---|---|---|
| WWAN - primary | 748-782, 824-960, | 1 | | 1 |
| | 1710-2170 | | | |
| | 450 | | 1 | 1 |
| WWAN - diversity | 450, 748-782, 869-960, | | 1 | 1 |
| | 1880-2170 | | | |
| MediaFLO/UMB | 174-240, 470-862, | 1 | | 1 |
| | 1452-1492 | | | |
| GPS | 1565-1585 | 1 | 1 | 2 |
| WLAN/BT - primary | 2400, 5800 | 1 | | 1 |
| WLAN/BT - diversity | 2400, 5800 | | 1 | 1 |
| WLAN/BT - MIMO | 2400, 5800 | | 3 | 3 |
| FM | 88-108 | 1 | 1 | 2 |
| NFC | 13.56 | 1 | | 1 |
| Wireless charging | 13.56 | 1 | | 1 |
| Total | | 7 | 8 | 15 |

In an aspect, a set of antennas may be shared by a set of radios on a wireless device in order to reduce the number of antennas required by the wireless device. In one design, antenna sharing may be performed dynamically (whenever needed) and adaptively (based on current conditions). One or more suitable antennas may be selected for one or more active radios at any given moment. This may ensure good performance regardless of which radio(s) are selected for use. Antenna sharing may be especially beneficial when the number of antennas is less than the number of radios supported by the wireless device, which may often be the case for a multi-function wireless device.

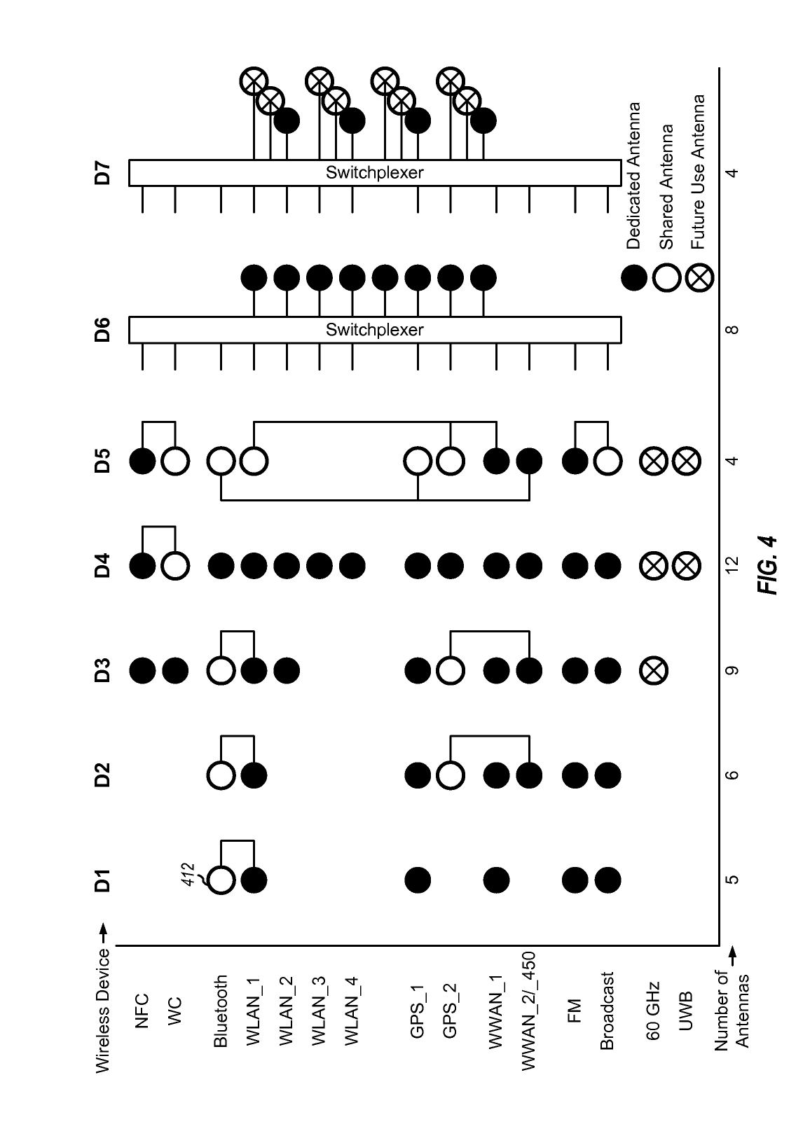

FIG. 4 shows different levels of antenna sharing by seven different wireless devices D1 through D7. Different combinations of radios, frequency bands, and operating modes are listed on the left side of FIG. 4. The radios, frequency bands, and operating modes supported by each wireless device are denoted by a set of dots below the wireless device. For example, wireless device D1 supports Bluetooth, WLAN, GPS, WWAN/cellular, FM, and broadcast. The set of dots for each wireless device also represent the set of antennas for the wireless device. A solid dot denotes a dedicated antenna being used for a particular radio. A white dot denotes an antenna being used for a particular radio and also shared with another radio to which the dot is linked. A dot with “x” denotes an antenna that may be used for a future radio. For example, wireless device D1 includes an antenna 412 that is used for Bluetooth and is shared with WLAN at 2400 MHz.

As shown in FIG. 4, as more radios are supported (e.g., going from wireless device D1 to D2, then to D3, and then to D4), the number of antennas increases. Antenna sharing may or may not be possible depending on various factors such as concurrency use cases between the radios, the operating frequency bands, the physical locations of the radios, the size and shape of wireless device 110, etc. Wireless device D6 includes a switchplexer that can map radios to a set of antennas. Wireless device D7 includes multiple antennas that can be used for beamsteering.

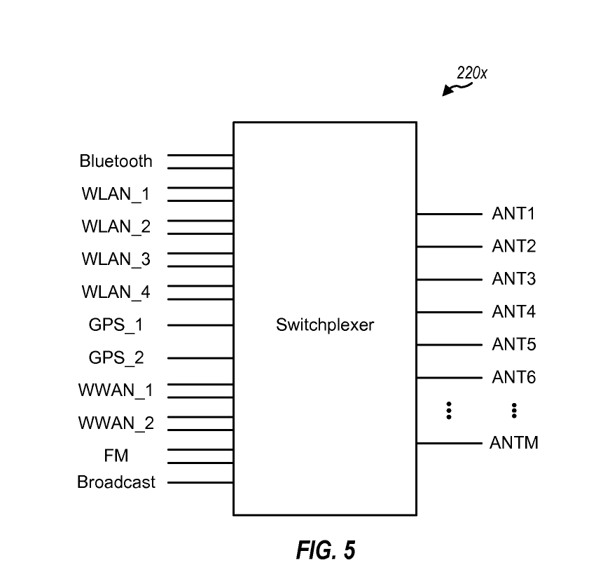

FIG. 5 shows a block diagram of a design of a switchplexer 220x that may be used to support antenna sharing in a wireless device. Switchplexer 220x may be one design of switchplexer 220 in FIGS. 2 and 3. Switchplexer 220x may include a set of inputs and a set of outputs. The inputs may be coupled to different radios supported by the wireless device. FIG. 5 illustrates an exemplary set of radios that may be supported. In FIG. 5, each radio technology (e.g., WLAN) supporting bi-directional communication is represented by double lines—one line for a transmitter radio and another line for a receiver radio. Each radio technology (e.g., GPS) supporting uni-directional communication is represented by a single line for a receiver radio.

In general, switchplexer 220 may be implemented with a configurable antenna switch matrix that can map a subset of N inputs for the N radios to M outputs for the M antennas. Switchplexer 220 may be implemented with RF switches and/or other circuit components. Switchplexer 220 may also be implemented with micro-electromechanical systems (MEMS) components, thin film bulk acoustic resonator (FBAR) filters, Si MEM resonators, switch capacitors, integrated passive devices (IPDs), controllable impedance elements, and/or other circuits to obtain high quality factor (Q), low loss, high linearity, etc.

Switchplexer 220 may also be implemented with multiple smaller switchplexers and/or RF switches. For example, switchplexer 220 may include (i) a first switchplexer coupled to a first set of radios and a first set of antennas and (ii) a second switchplexer coupled to a second set of radios and a second set of antennas. The different sets of antennas may correspond to different frequency bands, different radio technologies, different types of antennas, etc. For example, one set may include dedicated antennas for one set of radios, and another set may include shared antennas for another set of radios.

In one design, the M antennas 210a through 210m in FIG. 2 may each be a shared antenna. A shared antenna is an antenna that may be used for two or more radios (e.g., for WLAN and Bluetooth). A shared antenna may be used for one radio at any given moment or for multiple radios at the same time. In another design, the M antennas 210a through 210m may include at least one dedicated antenna and at least one shared antenna. A dedicated antenna is an antenna that is used for a specific radio. For both designs, the shared antenna(s) may be assigned to active radios such that good performance can be obtained.

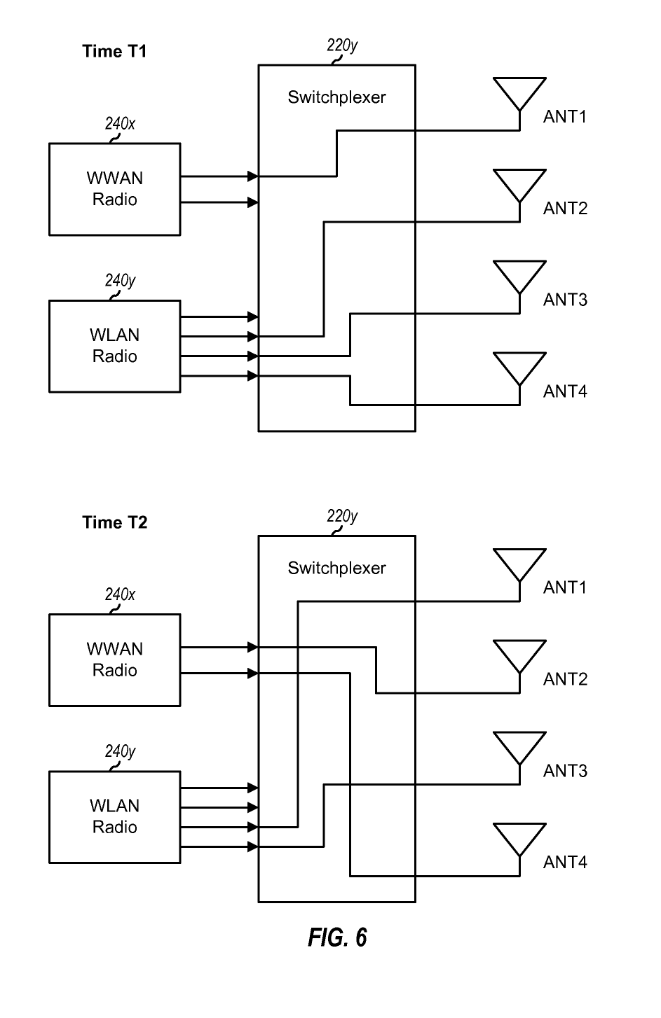

FIG. 6 shows an example of dynamic antenna selection for a case of two active radios and four antennas. A WWAN radio 240x may operate with only a primary antenna or both a primary antenna and a diversity antenna. A WLAN radio 240y may support MIMO operation with two, three, or four antennas. More antennas may be used for WLAN radio 240y to increase throughput and/or improve other performance metrics. However, at least one antenna may be required for WWAN radio 240x in order to satisfy a minimum throughput requirement of the WWAN radio. A switchplexer 220y may couple each radio to its assigned antenna(s).

At time T1, WWAN radio 240x may be assigned one antenna 1, and WLAN radio 240y may be assigned three antennas 2, 3 and 4. The performance of WWAN radio 240x and WLAN radio 240y may be monitored. A determination may be made that WWAN radio 240x does not meet the minimum throughput requirement of the WWAN radio. As a result, at time T2, WWAN radio 240x may be assigned two antennas 2 and 4 for diversity improvement. WLAN radio 240y may then be assigned the two remaining antennas 1 and 3 since its minimum throughput requirement is satisfied.

In general, any number of radios may be active at any given moment, and any number of antennas may be available. For example, Bluetooth, GPS, and/or other radios may be active along with WWAN radio 240x and WLAN radio 240y, and antennas may be allocated to these other active radios as well.

As shown in FIG. 6, a given radio may be assigned a configurable number of antennas based on its requirements. The number of antennas assigned to the radio may change over time due to the achieved performance of the radio and/or other radios, changes in channel conditions, changes in the requirements of the radio and/or other radios, hand placement, isolation changes, etc. The radio may also be assigned different antennas at different times based on the performance and requirements of the radio and/or other radios, the available antennas, etc. The number of antennas to assign to the radio and which particular antenna(s) to assign may be determined based on various metrics, as described below. In the example shown in FIG. 6, WWAN radio 240x is assigned antenna 1 at time T1 and switches to antenna 2 and 4 at time T2. Correspondingly, WLAN radio 240y is assigned antennas 2, 3 and 4 at time T1 and switches to antennas 1 and 2 at time T2.

In one design, controller 270 (e.g., connection manager 272 and/or coexistence manager 274) may select and assign antennas 210 to active radios 240 depending on various factors such as which applications are active on wireless device 110, which radios are active concurrently, the operating conditions of wireless device 110, etc. Controller 270 may arbitrate between various active radios when a coexistence problem is detected. Controller 270 may also control the tuning of each antenna 210 via the associated impedance control element 212 for the appropriate radio 240 and frequency band. Controller 270 may configure the antennas for receive diversity, selection diversity, MIMO, beamforming, etc., for any of the active radios.

Controller 270 may control the configuration and operation of switchplexer 220 to connect the active radios to the antennas assigned to these radios. This control may be based on a configurable or fixed mapping, depending on whether real-time or a priori measurements are available. Switchplexer 220 may implement a configurable antenna switch matrix with the ability to map a subset of radios 240 to a fixed number of antennas 210. For example, controller 270 may assign multiple antennas to a WWAN radio for diversity during a voice or data connection. Controller 270 may switch one or more of these multiple antennas to a WLAN radio for diversity or MIMO when the WWAN radio is not in use, or when requirements dictate, or based on some other criteria.

Controller 270 in conjunction with switchplexer 220 may perform various functions, which may include one or more of the following:
Support switching between a transmitter radio and a receiver radio for communication with a time division duplex (TDD) network,
Support diplexing between a transmitter radio and a receiver radio for communication with a frequency division duplex (FDD) network,
Support mode/band switching of radios and/or antennas,
Control antenna outputs for beamsteering,
Provide adaptable/tunable antenna matching, and
Support configurable RF front-end (RFFE) with tunable/switchable RF filters, switched filter banks, tunable matching networks, etc.

The use of controller 270 to support antenna selection may provide various advantages. For example, controller 270 may be able to mitigate interference between active radios, reduce the number of antennas required by wireless device 110, dynamically allocate system resources, improve performance, provide enhanced user experience, etc.

In another aspect, wireless device 110 may include one or more configurable antennas that can be varied to obtain good performance. A configurable antenna may be implemented with various designs and may have one or more attributes that may be varied to change the operating characteristics of the antenna. For example, one or more physical dimensions (e.g., length and/or size) of the configurable antenna may be varied.

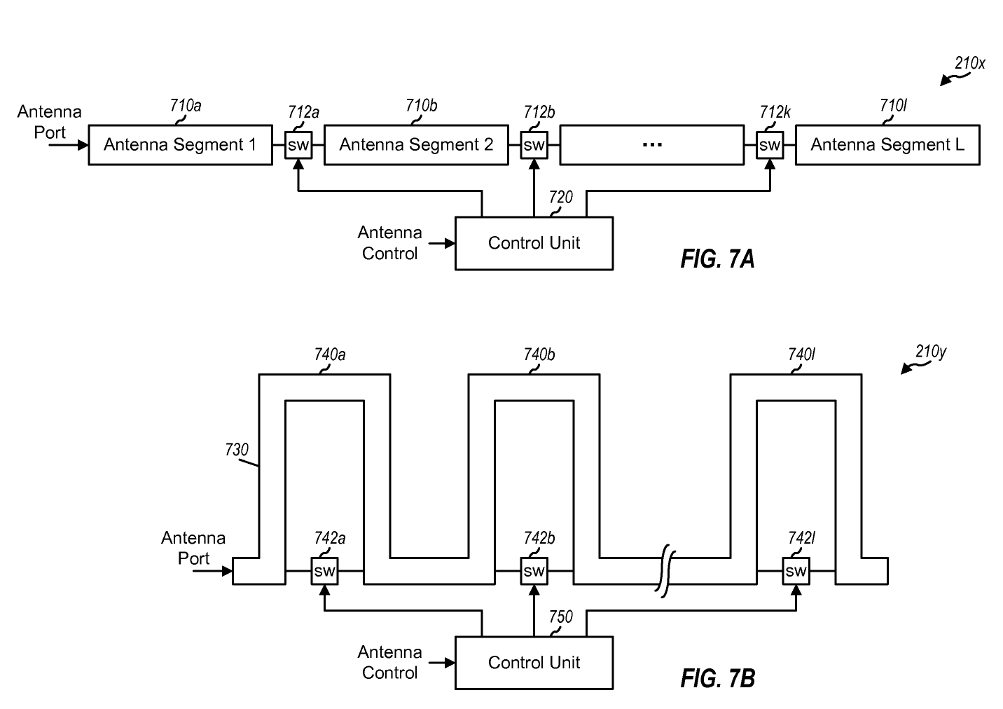

FIG. 7A shows a diagram of a design of a configurable antenna 210x, which may be used for any one of antennas 210a through 210m on wireless device 110 in FIG. 2. In the design shown in FIG. 7A, antenna 210x includes L antenna segments 710a through 710l, where L may be any integer value. The L antenna segments 710 may have the same length and width dimension or different dimensions. In the design shown in FIG. 7A, L−1 switches (sw) 712a through 712k are coupled between the L antenna segments 710a through 710l, with each switch 712 being coupled between two antenna segments. Each switch 712 may be activated to connect the two antenna segments coupled to the switch. Different numbers of antenna segments 710 may be connected together by activating different combinations of switches 712. Although not shown in FIG. 7A for simplicity, bypass paths may be used to route signal around antenna segments that are not connected. For example, a bypass path may be used to connect antenna segment 710a to the output of antenna 210x when the remaining antenna segments 710b through 710k are not connected. A control unit 720 may receive an antenna control and may generate control signals for switches 712a through 712k such that one or more desired antenna segments are connected.

FIG. 7B shows a diagram of a design of a configurable antenna 210y, which may also be used for any one of antennas 210a through 210m on wireless device 110 in FIG. 2. In the design shown in FIG. 7B, antenna 210y includes a trace 730 forming L antenna segments 740a through 740l, where L may be any integer value. Each segment 740 is arranged in a loop having one open end. The L antenna segments 740 may have the same dimension or different dimensions. In the design shown in FIG. 7B, L switches 742a through 742l are coupled to the L antenna segments 740a through 740l, respectively, with each switch 742 being coupled between the open end of each antenna segment 740. Each switch 742 may be activated to connect the open end of the associated antenna segment 740 and to essentially bypass the antenna segment. Different numbers of antenna segments 740 may be bypassed by activating different combinations of switches 742. A control unit 750 may receive an antenna control and generate control signals for switches 742a through 742l such that one or more desired antenna segments are selected and the remaining antenna segments are bypassed.

FIGS. 7A and 7B show exemplary designs of configurable antennas 210x and 210y. A configurable antenna may also be implemented with other designs.

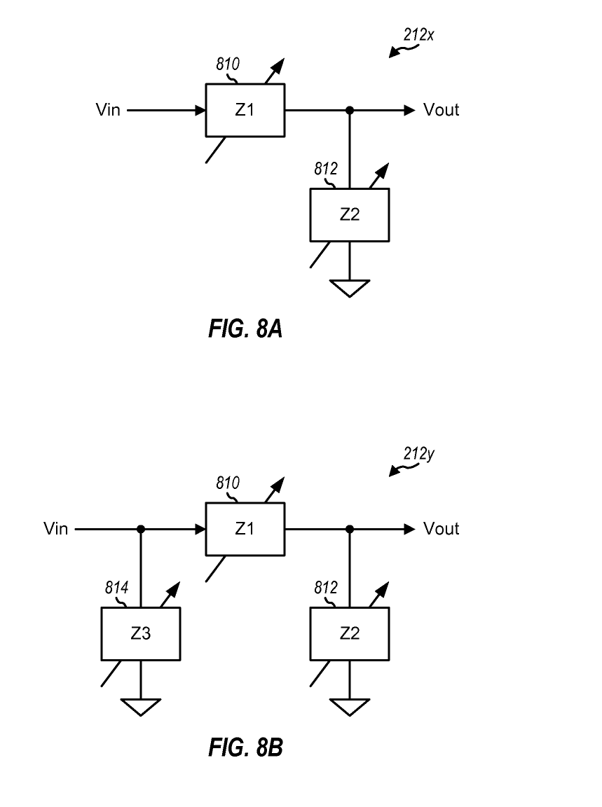

FIG. 8A shows a block diagram of a design of an impedance control element 212x, which may be used for any one of impedance control elements 212a through 212m on wireless device 110 in FIG. 2. In the design shown in FIG. 8A, impedance control element 212x includes a series impedance circuit 810 and a shunt impedance circuit 812. Series impedance circuit 810 is coupled between the input and output of impedance control element 212x. Shunt impedance circuit 812 is coupled between the output of impedance control element 212x and circuit ground. Each impedance circuit may be implemented with one or more inductors, one or more capacitors, etc. Each impedance circuit may be adjustable (as shown in FIG. 8A) or may be fixed. An adjustable impedance circuit may have an adjustable capacitor and/or some other adjustable circuit element. Different impedances may be obtained by varying the adjustable impedance circuit(s) within impedance control element 212x.

FIG. 8B shows a block diagram of a design of another impedance control element 212y, which may also be used for any one of impedance control elements 212a through 212m on wireless device 110 in FIG. 2. Impedance control element 212y includes series impedance circuit 810 and shunt impedance circuit 812 in impedance control element 212x in FIG. 8A. Impedance control element 212y further includes a shunt impedance circuit 814 coupled between the input of impedance control element 212y and circuit ground. Each impedance circuit may be adjustable or may be fixed. Different impedances may be obtained by varying the adjustable impedance circuit(s) within impedance control element 212y.

FIGS. 8A and 8B show exemplary designs of impedance control element 212x and 212y. An impedance control element may also be implemented with other designs. For example, an impedance control element may be implemented with multiple stages of impedance circuits to provide more flexibility in control.

In yet another aspect, measurements may be made for available antennas and may be used to select antennas for use and/or to assign antennas to active radios. Various types of measurements may be made for the available antennas and may include isolation measurements, RSSI measurements, etc.

In one design, isolation between antennas 210 on wireless device 110 may be measured in real-time and/or a priori. In one design, isolation between antennas may be measured for different combinations of antennas and possibly for different configurable settings of the antennas, different tuning states of the associated impedance control elements, and/or different device operating states (e.g., different power amplifier levels). The isolation measurements may be used to select and assign antennas. The isolation measurements may also be stored on wireless device 110 and may be retrieved at a later time for use to select and assign antennas.

Isolation is related to mutual coupling between antennas and is dependent on the interaction of an antenna with its environment. Isolation may change with hand placement, body position and proximity, surroundings, orientation of the case for wireless device 110, etc. Isolation may also be a function of antenna type, antenna shape, antenna placement on a circuit board, etc. For example, different antenna types and shapes may result in different levels of isolation even for the same physical separation and placement. Reduced isolation may adversely impact antenna performance such as reduced efficiency, gain, diversity performance, etc. Isolation may also cause shifts in the bandwidth and/or center frequency of an antenna from its designed bandwidth and center frequency. Consequently, reduced isolation may compromise radio performance, range, battery life, throughput, and communication quality.

Isolation may be described by scattering or S parameters (e.g., as a function of frequency) of an M-port device, which may correspond to M terminals of the M antennas 210a through 210m on wireless device 110. Isolation or mutual coupling may be an important criterion in determining the performance of radios 240 and may also be used to calculate correlation between antennas, which may affect the performance of MIMO transmission, transmit diversity, etc.

In one design, pair-wise isolation may be measured for different pairs of antennas on wireless device 110. Pair-wise isolation between two antennas i and j may be a function of frequency f and may be denoted as I_{i,j}(f), for i, j=1, 2, . . . , M and i≠j.

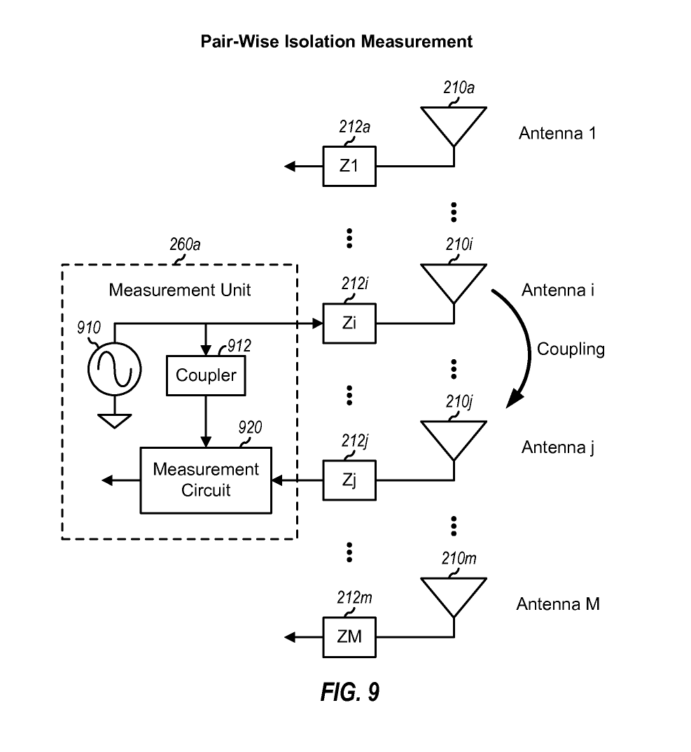

FIG. 9 shows a design of measuring pair-wise isolation for two antennas i and j, which may be any two of the M antennas 210a through 210m on wireless device 110. Within a measurement unit 260a, which may be one design of measurement unit 260 in FIG. 2, a signal source 910 may provide a test signal to antenna i and also to a coupler 912. Signal source 910 may be a local oscillator on wireless device 110, which may be tuned to the proper frequency. Coupler 912 may couple a portion of the test signal to a measurement circuit 920, which may also receive an input signal from antenna j. Measurement circuit 920 may measure the voltage, current, power, and/or some other electrical characteristics of the coupled signal from coupler 912 and the input signal from antenna j. The measurements from unit 920 may be used to determine pair-wise isolation between antennas i and j. For example, unit 920 may provide voltage measurements for the coupled signal and the input signal, which may be used to compute a scattering parameter (or S-parameter) for antennas i and j as follows:

$${S}_{i , j} ( f ) = \frac{{V}_{j} ( f )}{{V}_{i} ( f )} , \qquad Eq ( 1 )$$

where
Vᵢ(f) is the measured voltage of the test signal provided to antenna i,
Vⱼ(f) is the measured voltage of the input signal from antenna j, and
S_{i,j}(f) is the S-parameter for antennas i and j.

The pair-wise isolation between antennas i and j may be computed based on the S-parameter for antennas i and j, as follows:

I_{i,j}(f)=−20 log₁₀|S_{i,j}(f)| Eq (2)

where I_{i,j}(f) is the pair-wise isolation between antennas i and j.

The S-parameter S_{i,j}(f) is a complex quantity. The isolation I_{i,j}(f) is a scalar quantity that is a positive value as defined in equation (2). The measured power of the test signal may be equal to the measured power of the coupled signal from coupler 912 times a coupling factor for coupler 912. As shown in equations (1) and (2), pair-wise isolation may be determined based on a ratio of the voltage of an input signal received from another antenna to the voltage of an output signal provided to one antenna. A larger I_{i,j}(f) value would correspond to better isolation between the antennas. The term “coupling” may be the inverse of isolation, and it is desirable to have small couplings or large isolation.

Pair-wise isolation measurements may be obtained for different pairs of antennas on wireless device 110. The pair-wise isolation measurement for each antenna pair may be obtained by exciting one antenna in the pair and measuring the coupling to the other antenna in the pair. In one design, pair-wise isolation may be measured for M antennas 210a through 210m on wireless device 110 as follows. A test signal may be applied to antenna 210a, and an input signal from each of the remaining antennas 210b through 210m may be measured. Pair-wise isolation I_{1,2}(f) through I_{1,M}(f) may be computed based on the measurements for antennas 210a through 210m. The same process may be repeated for each of antennas 210b through 210m. In general, a test signal may be applied to one transmit antenna at a time, and the impact on the remaining M−1 receive antennas may be measured. An M×M scattering matrix may be obtained for the M antennas 210, with entry S_{i,j}(f) in the i-th row and j-th column corresponding to the pair-wise isolation between antennas i and j. Controller 270 may direct the test signal to be applied to appropriate antennas and may also direct measurement unit 260 to perform measurements for all affected antennas. Controller 270 may compute the isolation for different antenna pairs based on the measurements obtained from measurement unit 260.

In one design, antennas with better isolation may be selected for use. For example, if I_{1,2}(f)>I_{1,3}(f) at a particular frequency of operation, then antennas 1 and 2 may be selected for use instead of antennas 1 and 3.

In another design, joint isolation may be measured for different sets of three or more antennas. Joint isolation refers to isolation between at least one antenna and two or more other antennas. Joint isolation may be especially applicable when multiple transmitter radios and at least one receiver radio operate concurrently. In this case, joint isolation from multiple transmit antennas for the transmitter radios to at least one receive antenna for at least one receiver radio may be measured and used for antenna selection. Joint isolation for a set of antennas including multiple transmit antennas i through j and a receive antenna k may be a function of frequency f and may be denoted as I_{i, . . . j:k}(f), for i, . . . j, k=1, 2, . . . , M and i≠ . . . ≠j≠k. Joint isolation for a set of antennas including multiple transmit antennas i through j and multiple receive antennas k through m may be a function of frequency f and may be denoted as I_{i, . . . , j:k, . . . , m}(f).

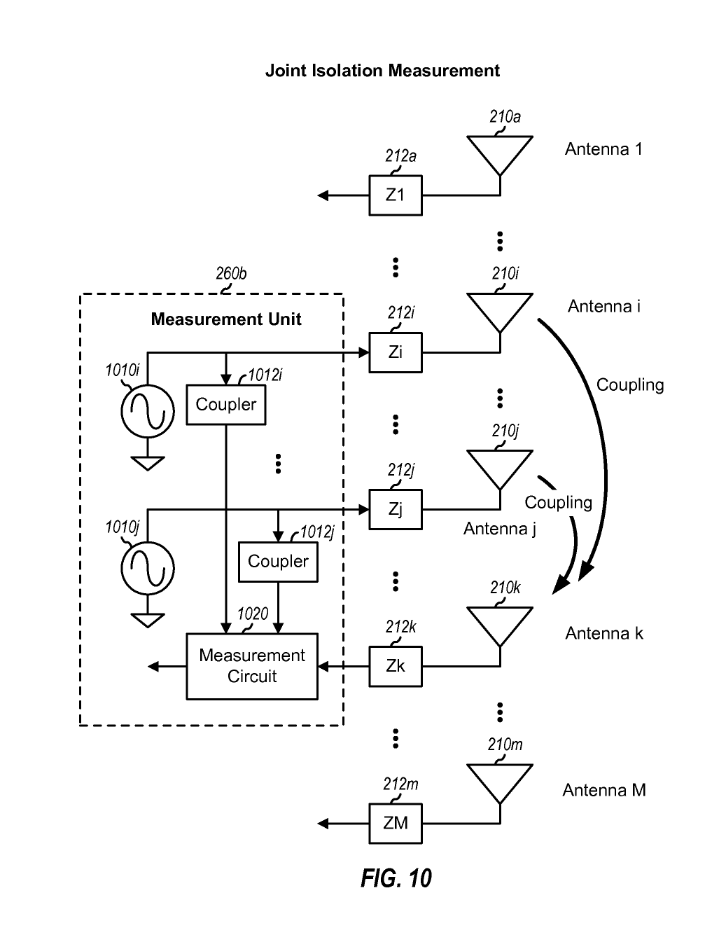

FIG. 10 shows a design of measuring joint isolation for a set of antennas, which may include multiple transmit antennas i through j and a receive antenna k. Antennas i through k may be any three or more of the M antennas 210a through 210m on wireless device 110.

Within a measurement unit 260b, which may be one design of measurement unit 260 in FIG. 2, multiple signal sources 1010i through 1010j may provide test signals to multiple antennas i through j, respectively, and also to multiple coupler 1012i through 1012j, respectively. Each coupler 1012 may couple a portion of its test signal to a measurement circuit 1020, which may also receive an input signal from receive antenna k. Measurement circuit 1020 may measure the voltage, current, power, and/or some other electrical characteristics of the coupled signal from each coupler 1012 and the input signal from receive antenna k. The measurements from unit 1020 may be used to determine the joint isolation between transmit antennas i through j and receive antenna k. For example, unit 1020 may provide voltage measurements for the coupled signals and the input signal, which may be used to compute the joint isolation between antennas i, . . . , j and k as follows:

I_{i, . . . j:k}(f)=g{Vᵢ(f), . . . ,Vⱼ(f):Vₖ(f)}, Eq (3)

where g{ } is a suitable function for joint isolation versus voltage measurements for different transmit and receive antennas. A larger I_{i, . . . j:k}(f) value may correspond to better joint isolation between the transmit antennas and the one or more receive antennas.

In one design, joint isolation may be measured for M antennas 210a through 210m on wireless device 110 as follows. Q test signals may be applied to Q transmit antennas, where Q>1, and M−Q input signals from the remaining M−Q receive antennas may be measured. Joint isolation may then be determined for each of the M−Q receive antennas based on the measurements for all antennas. For example, two test signals may be applied to two transmit antennas 1 and 2, and joint isolation I_{1,2:3}(f) through I_{1,2:M}(f) may be obtained for the remaining receive antennas 3 through M, respectively. The same process may be repeated for other combinations of transmit antennas. For each combination, test signals may be applied to the transmit antennas, and the impact on the remaining receive antennas may be measured. The number of permutations for joint isolation may be larger than the number of permutations for pair-wise isolation, which may require more measurement and storage resources. However, joint isolation may provide more accurate indication of isolation between different antennas and may provide better performance for antenna selection.

In general, isolation may be measured for different sets of antennas, and each set may include two or more antennas. Isolation may also be measured for (i) different tuning states of the impedance control elements associated with the antennas and/or (ii) different frequencies. In one design, isolation may be measured a priori (e.g., during manufacturing phase, during calibration or setup phase, and/or in the field), and the isolation measurements may be used for antenna selection. In another design, isolation may be measured periodically (e.g., synchronously) or when triggered (e.g., asynchronously), and the latest isolation measurements may be used for antenna selection.

As noted above, an antenna may be tuned to adjust its bandwidth and center frequency. Isolation between the antenna and other antennas may change as the antenna is tuned. In one design, isolation between antennas may be measured for different tuning states of the antennas. For example, an antenna may be tuned by turning segments of the antenna on or off, or by adjusting its impedance control element or matching network, and/or by varying other elements or circuits associated with the antenna. The bandwidth and center frequency of the antenna may vary as the antenna is tuned, and isolation may improve as the bandwidth of the antenna is changed.

Isolation measurements for different sets of antennas for different tuning states may be used to select antennas for use. In one design, for each antenna, tuning states that can provide the desired performance (e.g., the desired bandwidth and center frequency) may be considered, and remaining tuning states may be omitted. For each set of antennas, the tuning states of the antennas that can provide the best isolation between these antennas may be selected. Antennas may then be selected for use based on the best isolation for different sets of antennas. Antennas may also be selected for use by evaluating different tuning states of the antennas in other manners.

In one design, correlation between antennas 210 on wireless device 110 may be determined in real-time and/or a priori. Correlation is an indication of how independent an antenna is from other antennas. Correlation between antennas may have a large impact on performance for MIMO, transmit diversity, receive diversity, etc. In particular, antennas with low correlation may be able to provide better performance than antennas with high correlation.

Correlation between antennas may be determined by measuring far-field 3-dimensional (3D) radiated antenna pattern. However, this measurement is difficult to perform and is impractical in a typical wireless device. This measurement difficulty may be avoided by exploiting the relationship between isolation and correlation.

In one design, pair-wise correlation for a pair of antennas may be computed based on pair-wise isolation measurements for different pairs of antennas, as follows:

$${ρ}_{i , j} ( f ) = \frac{{\vert {\sum }_{m = 1}^{M} {S}_{i , m}^{*} ( f ) \cdot {S}_{m , j} ( f ) \vert}^{2}}{{\prod }_{k = i , j} ( 1 - {\sum }_{m = 1}^{M} {S}_{k , m}^{*} ( f ) \cdot {S}_{m , k} ( f ) )} , \qquad Eq ( 4 )$$

where S_{i,m}(f) is the S-parameter between antennas i and m, and
ρ_{i,j}(f) is the pair-wise correlation between antennas i and j.

In one design, joint correlation between antennas may be determined for different combinations of antennas and possibly for different tuning states of the associated impedance control elements and/or different settings of the antennas. The correlation measurements may be used to select and assign antennas. The correlation measurements may also be stored on wireless device 110 and retrieved at a later time for use to select and assign antennas.

Pair-wise correlation for different pairs of antennas on wireless device 110 may be determined based on pair-wise isolation measurements. Antennas may be selected based on the correlation measurements. Two antennas may be selected by choosing the pair of antennas with the lowest/smallest correlation. For example, if ρ_{1,2}(f)<ρ_{1,3}(f) at a particular frequency of operation, then antennas 1 and 2 may be selected for use instead of antennas 1 and 3. Three antennas may be selected by choosing two pairs of antennas with the two smallest correlation values. Antennas may also be selected based on correlation in other manners.

In one design, joint correlation for a set of three of more antennas may be computed based on pair-wise isolation measurements for different pairs of antennas and/or joint isolation measurements for different sets of three of more antennas. A suitable function may be defined for joint correlation, e.g., in similar manner as equation (4) for pair-wise correlation. Joint correlation may then be computed in accordance with the function and based on suitable isolation measurements.

In one design, antenna selection may be performed based on static measurements in order to reduce implementation and processing complexity. In one design, isolation measurements may be obtained a priori for antennas 210 on wireless device 110 and may be stored in database 290, e.g., in a look-up table (LUT). Database 290 may thereafter be utilized to select antennas with the largest isolation and suitable for a set of active radios in a given time period. In one design, when an additional radio becomes active, the next best antenna with the largest isolation between it and the previously selected antennas may be selected. When a previously active radio becomes inactive, the antenna previously selected for the radio may be de-selected. In another design, antenna selection may be performed anew for all active radios whenever there is a change in the set of active radios. This design may allow antennas to be re-assigned whenever a new radio becomes active or a previously active radio becomes inactive.

In one design, correlation between antennas may be determined a priori and stored in database 290. Correlation measurements for different antennas may be retrieved from database 290 and used to select antennas. In one design, antennas with the lowest correlation may be selected to obtain good performance for MIMO transmission, diversity, etc. In another design, the gain and balance of each antenna may be measured and stored in database 290. The gain and balance measurements for different antennas may be retrieved from database 290 and used to select antennas. Other characteristics of antennas 210 may also be measured or determined a priori and stored in database 290 for use to select antennas.

In another design, antenna selection may be performed based on dynamic measurements in order to improve performance in light of changing operating conditions. In one design, isolation measurements may be obtained for antennas 210 periodically or whenever triggered. A trigger may occur due to a change in the set of active radios, degradation in performance, etc. Antenna selection may then be performed based on the latest available isolation measurements. The isolation for a given antenna may fluctuate widely over time. Large fluctuations in the isolation for the antenna may be exploited, and the best antenna may be selected at times of high isolation.

In another design, correlation between antennas may be determined periodically or whenever triggered. Antenna selection may be performed based on the latest correlation measurements. In yet another design, the gain and balance of each antenna may be measured periodically or whenever triggered. Antenna selection may be performed based on the latest gain and balance measurements. Other characteristics of antennas may also be determined periodically or whenever triggered, and the latest measurements may be used for antenna selection.

In general, antennas may be selected for use and assigned to radios based on various performance metrics such as isolation between antennas, correlation between antennas, throughput of active radios, priorities of radios, interference between radios, power consumption of individual radios 240 and/or wireless device 110, channel conditions observed by wireless device 110, etc. Throughput may correspond to a data rate of a particular radio or an overall data rate of a set of radios or all radios. Throughput of one or more radios may be a function of the interference between radios, diversity performance in a multi-antenna system, channel conditions, RSSI and sensitivity of receiver radios, etc. These various performance metrics may be used as optimization parameters for antenna selection.

Each performance metric (e.g., for isolation, correlation, or throughput) may be affected by various variables such as the number of antennas being selected, which particular antennas are selected, the mapping of antennas to radios, etc. Each performance metric may be determined by computation and/or measurement and may generally be a function of one or more variables. These variables may be referred to as “knobs” and may be adjusted or “tuned” to different states, which may be referred to as “knob states”. For example, the throughput of a given radio and its mapping to one or more antennas may be computed based on radio type, transmission parameters (e.g., modulation scheme, code rate, MIMO configuration, etc.), antenna mapping, isolation, channel conditions, RSSI, signal-to-noise ratio (SNR), etc. Alternately, throughput may be measured in different manners, including counting the number of information bits received within a given time period. Whether a given performance metric is computed or measured may be dependent on the performance metric type (e.g., isolation may typically be measured whereas correlation may typically be computed from the isolation measurements) and perhaps based on which optimization algorithm is selected for use.

In one design, one or more performance metrics (e.g., for isolation, correlation, interference, etc.) may be determined and used to compute an objective function. In one design, an objective function (Obj) may be defined as follows:

Obj=a₁·Isolation+a₂·Correlation+a₃·Throughput+a₄·Interference+a₅·PowerConsumption+a₆·SINR+ Eq (5)

where a₁ through a₆ are weights for different performance metrics, e.g., 0≦aₖ≦1.

In another design, an objective function may be defined as follows:

Obj=f_{obj}(Perf_Metric 1,Perf_Metric 2, . . . ,Perf_Metric P) Eq (6)

where Perf_Metric p denotes the p-th performance metric, and

f_{obj} may be any suitable function of one or more (P) performance metrics.

A purpose of the objective function is to define a function to be solved or optimized. The input parameters of the objective function may be determined by high-level requirements from one or more entities (e.g., connection manager 272 and/or coexistence manager 274), low-level parameters that contribute to the optimization, etc. The objective function may be represented by a specific formulation and a set of parameters, which may be defined or selected based on one or more objectives and possibly by the specific optimization algorithm selected for use. For example, the one or more objectives may relate to maximizing isolation, maximizing throughput, minimizing interference, minimizing power consumption, etc. These objectives may be fulfilled by using performance metrics for isolation, correlation, throughput, etc. For example, a particular antenna to radio mapping may increase isolation between a pair of antennas (which may decrease correlation) but may also decrease throughput for a radio (which may result in one antenna instead of two antennas being selected).

In the design shown in equation (5), the weights may determine how much emphasis or weight to place on the associated performance metrics. A weight of zero implies no emphasis on an associated performance metric whereas a weight of one implies full weight on the associated performance metric. The weight for each performance metric may be selected based on requirements from other entities such as connection manager 272, coexistence manager 274, etc. The performance metrics may be optimized based on their average values, or peak values (e.g., average or peak throughput, average or maximum interference, etc.) and over one radio, or a set of radios, or all radios.

The objective function may be subject to one or more constraints. In one design, each radio or each set of radios may need to satisfy a certain minimum throughput. In another design, the transmit power of each radio may be limited to a range of values and to not exceed the maximum capability of the radio. In yet another design, the total power consumption of a set of radios may be limited to a range of values. In still yet another design, a certain minimum or maximum number of antennas may be allocated to a particular radio or a set of radios in order to satisfy some predefined rules that may be separate from antenna selection. Other constraints may also be defined and used with the objective function.

In general, the objective function may be visualized as a multi-dimensional curve whose shape is determined by participating knobs/variables for all performance metrics being considered and the corresponding knob states. Each point on this curve may correspond to a particular set of participating knobs and their knob states. The best value (e.g., maximum or minimum) of the objective function may be achieved for a specific set of knob states (or values for each individual knob/variable). A number of algorithms may be used to determine this best value of the objective function. Different algorithms may implement different ways to determine the best value, and some algorithms may be more cost/time-efficient than others.

For example, a brute force algorithm may proceed as follows. First, one or more performance metrics and one or more objectives (e.g., maximum throughput) may be selected. Next, different possible sets of knobs and knob states may be evaluated. Each set of knobs and knob states may be associated with a particular antenna configuration, which may include a particular number of antennas to select, which particular antenna(s) to select, a particular mapping of antenna(s) to radio(s), etc. For each possible set of knobs and knob states, pertinent computations and/or measurements may be obtained, the performance metric(s) may be computed based on the computations and/or measurements, and the objective function may be determined based on the performance metric(s). The set of knobs and knob states that maximizes the one or more objectives (e.g., maximizes throughput) may be identified. The antenna configuration corresponding to the identified set of knobs and knob states may be selected for use. Other algorithms besides the brute force algorithm may also be used to evaluate the objective function and determine the best antenna configuration for use.

In one design, antenna selection may be based on an objective function that maximizes one or more normalized metrics such as throughput, received signal quality, isolation, etc. Received signal quality may be given by SNR, signal-to-noise-and-interference ratio (SINR), carrier-to-interference ratio (C/I), etc. In each scheduling interval, controller 270 may select one or more radios 240 for operation, and each selected radio may be a transmitter radio or a receiver radio. Controller 270 may also select one or more antennas 210 to support the selected radio(s). Controller 270 may select antennas independently of radios or may jointly select antennas and radios. If controller 270 selects antennas and radios independently, then controller 270 may determine which radios will be operational in a given time period and may map the active radios to a set of antennas based on selection criteria. If controller 270 jointly selects antennas and radios, then metrics for antennas (e.g., for isolation, correlation, etc.) may be weighted and used in combination with other weighted metrics to select radios. The other weighted metrics may correspond to throughput, priorities of active applications, interference between radios, etc.

Throughput may be used as a performance metric and a parameter of an objective function, e.g., as shown in equation (5) or (6). Throughput may be determined by computation or measurement. Throughput may be computed based on spectral efficiency (or capacity) and system bandwidth. Spectral efficiency may be computed in different manners for different transmission schemes, e.g., based on different computation expressions for these different transmission schemes. For example, the spectral efficiency of a MIMO transmission from multiple (T) transmit antennas to multiple (R) receive antennas may be expressed as:

$$SE = {log}_{2} [ det ( I + \frac{Γ}{T} {HH}^{H} ) ] , \qquad Eq ( 7 )$$

where H is an R×T channel matrix for the wireless channel from the T transmit antennas to the R receive antennas,

Γis an average received SNR,

det( ) denotes a determinant function,

I denotes an identity matrix,

“^{H}” denotes a Hermetian or conjugate transpose, and

SE denotes the spectral efficiency of the MIMO transmission in units of bps/Hz. The channel matrix H may also be a function of an isolation matrix, a correlation matrix, and/or other factors.

MIMO transmission may be used to increase throughput and/or improve reliability over single-antenna transmission. The spectral efficiency of MIMO transmission may be increased with more antennas and with larger SNR. The spectral efficiency of MIMO transmission may be used as a throughput metric for antenna selection and for assignment to MIMO-capable radios, such as LTE and WLAN radios. For non-MIMO capable radios, the spectral efficiency for diversity reception, selection combining (e.g., for 3G WAN, GPS), or single-antenna transmission (e.g., for Bluetooth, FM, etc.) may be used as a throughput metric for antenna selection. In one design, antenna selection may be performed such that the total throughput of all active radios may be maximized and also such that each active radio satisfies a minimum throughput constraint for that radio.

Each radio may operate over a different channel that may be considered to be independent of the channels for the other radios. Each radio may also be distinct from the other radios and may operate with different bandwidths, frequencies, etc. Higher throughput may be achieved for radios with better channel state. The channel state typically fluctuates over time and operating conditions such as fading, mobility, etc. The channel state may be conveyed by channel quality indicator (CQI), RSSI, SNR, and/or other information, which may be readily available in physical layer channels of air interfaces. Information indicative of the channel state of each radio may be provided (e.g., at regular update intervals) to controller 270. This information may be used to select radios and antennas such that throughput can be maximized.

An exemplary opportunistic scheduling algorithm may assign a radio-antenna combination with the best channel state in order to maximize the overall throughput. However, it may be desirable to insure that radio-antenna combinations with poorer channel state can maintain some minimum throughput. To facilitate this, a normalized ratio may be defined as follows:

$${R}_{i} ( t ) = \frac{{D}_{i} ( t )}{{A}_{i} ( t )} , \qquad Eq ( 8 )$$

where Dᵢ(t) is an achievable throughput of radio-antenna combination i over time slot t based on the reported channel state,

Aᵢ(t) is an average throughput of radio-antenna combination i, and

Rᵢ(t) is a normalized ratio for radio-antenna combination i.

The average throughput of radio-antenna combination i may be determined based on a moving average, as follows:

Aᵢ(t+1)=(1−δ)·Aᵢ(t)+δ·Dᵢ(t), if not scheduled Eq (9)

Aᵢ(t+1)=(1−δ)·Aᵢ(t), if scheduled Eq (10)

where δ=1/T_{WINDOW}, and T_{WINDOW} is the length of the averaging window. As shown in equations (9) and (10), the average throughput of radio-antenna combination i may be updated in different manners depending on whether or not radio-antenna combination i is scheduled. Other averaging methods may also be used.

For the design shown in equation (8), controller 270 may select radio-antenna combination i at each time slot in which Rᵢ(t) is the largest normalized ratio among all active radio-antenna combinations. This design may attempt to keep a fairness constraint for all radio-antenna combinations in terms of throughput. The optimization may be done in terms of the number of antennas and the particular antennas depending on their properties. If only the achievable throughput were maximized, then controller 270 may always select the radio-antenna combination with the best channel state, and radio-antenna combinations with relatively worse channel state would not achieve their potential throughput. Conversely, if only the average throughput were maximized, then controller 270 may act in a round-robin fashion and may select each radio-antenna combination equally often.

In one design, antenna selection may be based on isolation instead of channel state information. In one design, controller 270 may select the antenna with the largest isolation among all active radio-antenna combinations at each time slot. This design may reduce dependence on channel state information, and hence may reduce complexity and overhead needed for a feedback channel. In another design, antenna selection may be based on isolation in addition to channel state information. In yet another design, antenna selection may be based on joint optimization with isolation and one or more performance metrics (e.g., throughput).

Throughput may be dependent on isolation and may generally be better with higher isolation. An algorithm that utilizes isolation may have less implementation complexity since it uses local isolation measurements rather than link or path level throughput measurements. Maximizing isolation may or may not translate to maximum throughput. Furthermore, isolation may vary on a different time scale than channel state. Hence, a performance/complexity tradeoff may be made by utilizing isolation for antenna selection.

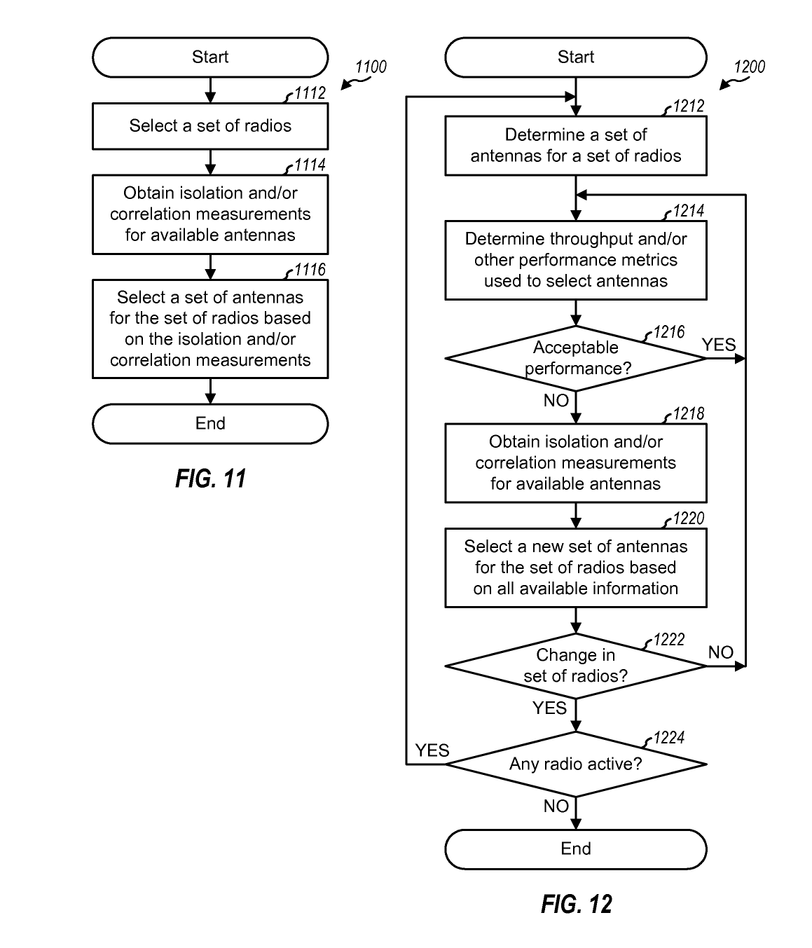

FIG. 11 shows a flow diagram of a design of a process 1100 for antenna selection. Process 1100 may be performed by wireless device 110, e.g., by controller 270. Initially, a set of one or more radios may be selected for use (block 1112). The radio(s) may be selected based on various criteria such as requirements of active applications on wireless device 110, preferences of the active applications, capabilities and priorities of the radios on wireless device 110, interference between the radios, etc. Isolation and/or correlation measurements for antennas available on wireless device 110 may be obtained (block 1114). The isolation and/or correlation measurements may be obtained a priori and stored in a database, or periodically, or whenever triggered. A set of one or more antennas may be selected for the set of radio(s) based on the isolation and/or correlation measurements (block 1116).

FIG. 12 shows a flow diagram of a design of a process 1200 for dynamic antenna selection. Process 1200 may also be performed by wireless device 110, e.g., by controller 270. A set of one or more antennas may be determined for a set of one or more active radios (block 1212). Block 1212 may be implemented with process 1100 in FIG. 11 or may be performed in other manners.

Throughput and/or other performance metrics used for antenna selection may be determined, e.g., periodically or whenever triggered by an event (block 1214). A determination may be made whether the performance of the set of active radios is acceptable (block 1216). If the answer is ‘Yes’, then the process may return to block 1214 to continue to monitor the throughput and/or other performance metrics used for antenna selection. Otherwise, if the performance is not acceptable, then isolation and/or correlation measurements for available antennas may be obtained, e.g., in real time or from a database (block 1218). A new set of one or more antennas may be selected for the set of active radios based on all of the available information, e.g., based on optimization of an objective function as described above (block 1220).

A determination may be made whether there is a change in the set of active radios (block 1222). If the answer is ‘No’, then the process may return to block 1214 to monitor the throughput and/or other performance metrics used for antenna selection. If the answer is ‘Yes’, then a determination may be made whether any radios are active (block 1224). If the answer is ‘Yes’, then the process may return to block 1212 to select a set of antennas for the set of active radios. Otherwise, if no radios are active, then the process may terminate.

In general, various performance metrics may be used to select antennas for active radios. These performance metrics may be used to determine how many antennas to select for each active radio as well as which particular antenna(s) to select for each active radio. For example, isolation and/or correlation measurements may be used to determine which pair or set of antennas have the best performance (e.g., the best isolation or lowest correlation) between them for a particular radio.

In one design, antenna selection may be performed in a centralized manner. In this design, decisions on which antennas to select for use and which antennas to assign to active radios may be made globally across all radios and antennas. In another design, antenna selection may be performed in a decentralized manner. In this design, decisions on which antennas to select for use may be made for each radio or each set of radios, e.g., such that the objective function is satisfied locally for that radio or that set of radios.

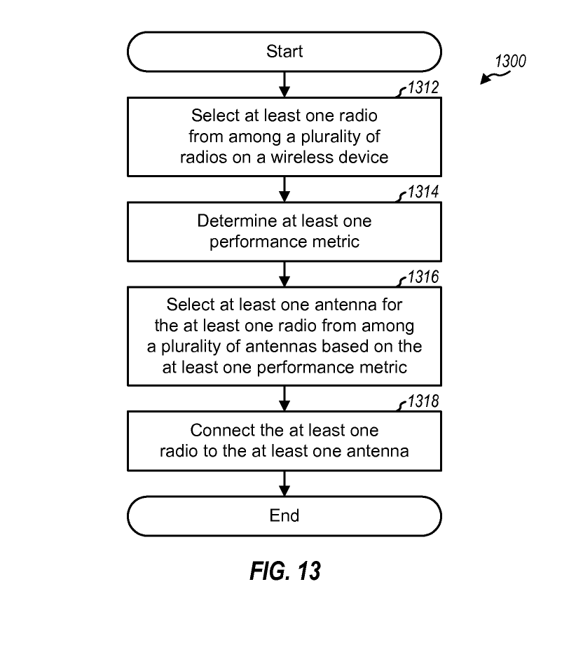

FIG. 13 shows a design of a process 1300 for performing antenna selection. Process 1300 may be performed by a wireless device or some other entity. At least one radio may be selected from among a plurality of radios on the wireless device (block 1312). At least one performance metric may be determined (block 1314). At least one antenna may be selected for the at least one radio from among a plurality of antennas based on the at least one performance metric (block 1316). The at least one radio may be connected to the at least one antenna (block 1318).

In general, the at least one performance metric may include any type of performance metric and any number of performance metrics. In one design, the at least one performance metric may include a performance metric related to isolation between antennas or correlation between antennas. In another design, the at least one performance metric may include a performance metric related to throughput, or link capacity, or interference, or power consumption of the wireless device, or received signal quality at the wireless device. In yet another design, the at least one performance metric may comprise a performance metric related to a normalized ratio of achievable throughput to average throughput for each of a plurality of radio-antenna combinations, e.g., as shown in equation (8). The at least one performance may also include a combination of the performance metrics described above.

In one design, an objective function may be determined based on the at least one performance metric. In one design, the at least one performance metric may include a plurality of performance metrics, and the objective function may comprise a weighted sum of the plurality of performance metrics, e.g., as shown in equation (5). The weight for each performance metric may be selected based on the objective(s) to be optimized and may be set to (i) a low value (or zero) to give low (or no) weight to the performance metric or (ii) a high value to give greater weight to the performance metric. In general, the objective function may be any function of the at least one performance metric. The at least one antenna may be selected based on the objective function, e.g., with an algorithm that optimizes the objective function as a function of the at least one performance metric and possibly subject to certain constraints.

In one design, the at least one radio and/or the at least one antenna may be selected based on at least one constraint. The at least one constraint may include a constraint for a particular minimum throughput for each radio or each set of radios, or for transmit power of each radio being limited to a range of values, or for a particular minimum or maximum number of antennas for each radio or each set of radios, or some other constraint.

In one design, the wireless device may determine at least one performance metric and select at least one antenna periodically or when triggered by an event (e.g., when the at least one radio selected). In another design, the wireless device may determine at least one performance metric and select at least one antenna iteratively, e.g., as shown in FIG. 12.

In one design, one or more antennas may be selected initially for the at least one radio, e.g., based on isolation between antennas, or correlation between antennas, or interference, or priorities of the plurality of antennas, or a combination thereof. The at least one radio may be connected to the one or more antennas. The at least one performance metric may be determined with the one or more antennas being used for the at least one radio. The at least one antenna may be selected based on the at least one performance and may then replace the one or more antennas. The at least one antenna may include some, all, or none of the one or more antennas.

In one design, the plurality of antennas may be available for use for the plurality of radios on the wireless device. The wireless device may determine the at least one performance metric and select the at least one antenna globally for all of the plurality of radios. In another design, the plurality of antennas may be available for a particular radio on the wireless device. The wireless device may determine the at least one performance metric and select the at least one antenna locally for the particular radio.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
selecting at least one radio from among a plurality of radios on a wireless device;
determining at least one performance metric;
selecting at least one antenna for the at least one radio from among a plurality of antennas based on the at least one performance metric; and
connecting the at least one radio to the at least one antenna.

2. The method of claim 1, further comprising:
determining an objective function based on the at least one performance metric; and
selecting the at least one antenna based on the objective function.

3. The method of claim 2, wherein the at least one performance metric comprises a plurality of performance metrics, and wherein the objective function comprises a weighted sum of the plurality of performance metrics.

4. The method of claim 1, wherein the at least one performance metric comprises a performance metric related to isolation between antennas or correlation between antennas.

5. The method of claim 1, wherein the at least one performance metric comprises a performance metric related to throughput, or link capacity, or interference, or power consumption of the wireless device, or received signal quality at the wireless device.

6. The method of claim 1, wherein the at least one performance metric comprises a performance metric related to a normalized ratio of achievable throughput to average throughput for each of a plurality of radio-antenna combinations.

7. The method of claim 1, wherein the at least one radio is selected from among the plurality of radios or the at least one antenna is selected from among the plurality of antennas based further on at least one constraint.

8. The method of claim 7, wherein the at least one constraint comprises a constraint for a particular minimum throughput for each radio or each set of radios, or for transmit power of each radio being limited to a range of values, or for a particular minimum or maximum number of antennas for each radio or each set of radios.

9. The method of claim 1, further comprising:
performing the determining at least one performance metric and the selecting at least one antenna periodically or when triggered by an event.

10. The method of claim 1, further comprising:
performing the determining at least one performance metric and the selecting at least one antenna iteratively.

11. The method of claim 1, further comprising:
selecting one or more antennas initially for the at least one radio; and
connecting the at least one radio to the one or more antennas, and
wherein the at least one performance metric is determined with the one or more antennas being used for the at least one radio.

12. The method of claim 11, wherein the one or more antennas are initially selected based on isolation between antennas, or correlation between antennas, or both.

13. The method of claim 11, wherein the one or more antennas are initially selected based on interference, or priorities of the plurality of antennas, or a combination thereof.

14. The method of claim 1, wherein the plurality of antennas are available for use for the plurality of radios on the wireless device, and wherein the determining the at least one performance metric and the selecting the at least one antenna are performed globally for all of the plurality of radios.

15. The method of claim 1, wherein the plurality of antennas are available for a particular radio on the wireless device, and wherein the determining the at least one performance metric and the selecting the at least one antenna are performed locally for the particular radio.

16. An apparatus for wireless communication, comprising:
means for selecting at least one radio from among a plurality of radios on a wireless device;
means for determining at least one performance metric;
means for selecting at least one antenna for the at least one radio from among a plurality of antennas based on the at least one performance metric; and
means for connecting the at least one radio to the at least one antenna.

17. The apparatus of claim 16, further comprising:
means for determining an objective function based on the at least one performance metric; and
means for selecting the at least one antenna based on the objective function.

18. The apparatus of claim 16, wherein the at least one performance metric comprises a performance metric related to isolation between antennas or correlation between antennas.

19. The apparatus of claim 16, wherein the at least one performance metric comprises a performance metric related to throughput, or link capacity, or interference, or power consumption of the wireless device, or received signal quality at the wireless device.

20. The apparatus of claim 16, further comprising:
means for performing the determining at least one performance metric and the selecting at least one antenna periodically or when triggered by an event.

21. The apparatus of claim 16, further comprising:
means for selecting one or more antennas initially for the at least one radio; and
means for connecting the at least one radio to the one or more antennas, and
wherein the at least one performance metric is determined with the one or more antennas being used for the at least one radio.

22. An apparatus for wireless communication, comprising:
at least one processor configured to select at least one radio from among a plurality of radios on a wireless device, to determine at least one performance metric, to select at least one antenna for the at least one radio from among a plurality of antennas based on the at least one performance metric, and to connect the at least one radio to the at least one antenna.

23. The apparatus of claim 22, wherein the at least one processor is configured to determine an objective function based on the at least one performance metric, and to select the at least one antenna based on the objective function.

24. The apparatus of claim 22, wherein the at least one performance metric comprises a performance metric related to isolation between antennas or correlation between antennas.

25. The apparatus of claim 22, wherein the at least one performance metric comprises a performance metric related to throughput, or link capacity, or interference, or power consumption of the wireless device, or received signal quality at the wireless device.

26. The apparatus of claim 22, wherein the at least one processor is configured to determine the at least one performance metric and to select the at least one antenna periodically or when triggered by an event.

27. The apparatus of claim 22, wherein the at least one processor is configured to select one or more antennas initially for the at least one radio, to connect the at least one radio to the one or more antennas, and to determine the at least one performance metric with the one or more antennas being used for the at least one radio.

28. A computer program product, comprising:
a computer-readable medium comprising:
code for causing at least one computer to select at least one radio from among a plurality of radios on a wireless device,
code for causing the at least one computer to determine at least one performance metric,
code for causing the at least one computer to select at least one antenna for the at least one radio from among a plurality of antennas based on the at least one performance metric, and
code for causing the at least one computer to connect the at least one radio to the at least one antenna.
